(19) United States
(12) Patent Application Publication
(10) Pub. No.: US 2010/0036678 A1
(43) Pub. Date: Feb. 11, 2010

(54) Systems and methods for providing a pharmaceutical to a patient

(76) Inventor: Gregory D. Bray, Fortville, IN (US)

Correspondence Address: KRIEG DEVAULT LLP, ONE INDIANA SQUARE, SUITE 2800, INDIANAPOLIS, IN, 46204-2079, US

(21) Appl. No.: 12/228,357

(22) Filed: Aug. 11, 2008

(51) Int. Cl. G06Q 50/00; G06Q 10/00

(52) U.S. Cl. 705/3

(57) ABSTRACT

Systems and methods are disclosed for providing a pharmaceutical to a patient. One embodiment includes filling a delivery device with a pharmaceutical, attaching a machine-readable and re-writable identifier to the delivery device and supplying the delivery device to an administration facility. The identifier contains pharmaceutical information identifying details of the pharmaceutical, such as one or more of the name, class, concentration, volume, expiration date, lot number, serial number and manufacturer of the pharmaceutical. At the administration facility, the identifier is read and the pharmaceutical information is compared with an electronic file uniquely associated with the patient to detect a confirmation for administering the pharmaceutical to the patient. If the confirmation is present, the pharmaceutical is administered to the patient and the pharmaceutical information is stored in the electronic file. Other embodiments include unique methods, systems, kits, assemblies, equipment, and/or apparatus which involve providing a pharmaceutical to a patient.

The present application relates to systems and methods for providing a pharmaceutical to a patient, and more particularly, but not exclusively, relates to reducing the risk of errors associated with administering a pharmaceutical to the patient. One nonlimiting embodiment of the present application is directed to a method which includes providing a confirmation to administer the pharmaceutical to the patient and updating an electronic patient file to include information identifying details of the pharmaceutical; however, in other embodiments, different applications are envisioned.

Many healthcare facilities rely on individual healthcare workers to administer or distribute pharmaceutical to patients. In one manner, the healthcare workers must consult a prescription or order prepared by a physician or other healthcare professional to ascertain details associated with administration of the pharmaceutical to the patient, including for example, the name and/or dosage specifications of the pharmaceutical, before administering the pharmaceutical to the patient. When healthcare workers properly follow this type of procedure, most patients receive the correct type and/or amount of a pharmaceutical. However, given the potential for human error associated with this manner of confirming proper administration of pharmaceuticals, some patients unfortunately receive the incorrect type and/or dosage of pharmaceuticals.

In certain instances, errors in the administration of a pharmaceutical to a patient increase where the pharmaceutical must be administered with a delivery device, such as a syringe. Often times, the healthcare workers must load a pharmaceutical into the delivery device from a container, such as a vial, in which the pharmaceutical is provided from the manufacturer. Transferring the pharmaceutical from the container to the delivery device places an extra burden on healthcare workers, increases the chances for contamination of the pharmaceutical and creates an additional opportunity for human error. Additionally, many pharmaceuticals share similar physical and visual characteristics, often leading to difficulties for healthcare workers in differentiating between multiple products. As an example, two separate pharmaceuticals each used to treat a distinct medical condition may be provided having identical, clear appearances. To help address the difficulty in differentiating between these pharmaceuticals, labels can be affixed to containers to identify details, such as name and concentration, of the pharmaceuticals. While these labels can help provide some degree of clarity between different products, a healthcare worker must read the labels to ensure that the proper pharmaceutical is loaded into the delivery device, giving rise to another opportunity for human error. Moreover, the labels do not assist the healthcare workers to distinguish between delivery devices which have been loaded with pharmaceuticals having similar appearances, and then set aside before use. To that end, there remains a significant potential for error associated with loading and subsequently administering a pharmaceutical to a patient with the delivery device. Thus, there is a need for additional contributions in this area of technology.

One embodiment of the present application is directed to a method of providing a pharmaceutical to a patient, which includes filling at least one delivery device with the pharmaceutical. The delivery device includes a machine-readable and re-writable identifier including information identifying manufacturing details and other properties and characteristics of the pharmaceutical. The method also includes supplying the at least one delivery device to an administration facility, reading the identifier at the administration facility and comparing the information on the identifier with a file uniquely associated with the patient to detect a confirmation for administering the pharmaceutical to the patient. In response to the confirmation, the pharmaceutical is administered to the patient and the information on the identifier is stored in the file.

Another embodiment of the present application is a unique system for providing a pharmaceutical to a patient. Other embodiments include unique methods, systems, devices, kits, assemblies, equipment, and/or apparatus related to providing a pharmaceutical to a patient.

Further embodiments, forms, features, aspects, benefits, objects, and advantages of the present application shall become apparent from the detailed description and figures provided herewith.

### BRIEF DESCRIPTION OF THE DRAWINGS

FIG. 1 is a perspective, partial cut-away view of one embodiment of a delivery device.

FIG. 2 is a perspective view of one embodiment of a flange engageable with the delivery device of FIG. 1.

FIG. 3 is a plan view of another embodiment of a flange engageable with the delivery device of FIG. 1.

FIG. 4 is a perspective view of an alternative embodiment of the flange illustrated in FIG. 2.

FIG. 5 is a schematic illustration of another portion of a system for providing a pharmaceutical to a patient.

FIG. 6 is a schematic illustration of another portion of the system of FIG. 5 for providing the pharmaceutical to the patient.

FIG. 7 is a flowchart depicting one procedure for administering the pharmaceutical to the patient at the administration station illustrated in FIG. 6.

### DETAILED DESCRIPTION OF REPRESENTATIVE EMBODIMENTS

While the present application can take many different forms, for the purpose of promoting an understanding of the principles of the application, reference will now be made to the embodiments illustrated in the drawings and specific language will be used to describe the same. It will nevertheless be understood that no limitation of the scope of the application is thereby intended. Any alterations and further modifications of the described embodiments, and any further applications of the principles of the application as described herein are contemplated as would normally occur to one skilled in the art to which the application relates.

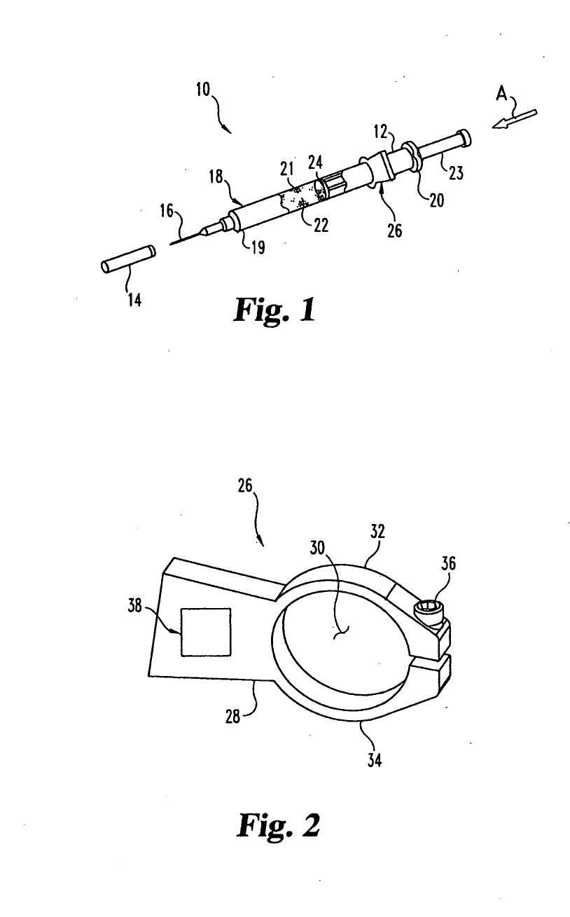

One embodiment of the present application is generally directed to providing and administering a pharmaceutical to a patient with a delivery device. Still, further aspects and features of the present application are described with respect to the illustrated embodiments as follows. For example, referring generally to FIG. 1, there is illustrated in a perspective, partial cut-away view a delivery device 10 in the form of syringe 12. However, different forms of delivery device 10 in addition to or in lieu of syringe 12 are contemplated. For example, in one or more forms, delivery device 10 may be a(n) bottle, pouch, ampoule, vial or a bag for holding and dispensing intravenous fluids, just to name a few possibilities. Additionally, while not illustrated, delivery device 10 may be provided in packaging to protect it during shipping and handling.

Syringe 12 includes a barrel 18 extending between a first end 19 and a second end 20. Barrel 18 defines an internal chamber 21 housing a quantity of pharmaceutical 22. Further details regarding pharmaceutical 22 will be provided below. Syringe 12 also includes a plunger 23 which engages with a radial opening (not shown) in second end 20 and is longitudinally translatable relative to barrel 18. Opposite plunger 23, a needle 16 engages with barrel 18 at first end 19 and is positionable in a cap 14 when syringe 12 is not in use. Needle 16 includes an elongated passageway (not shown) extending along its length and communicating with pharmaceutical 22 positioned in internal chamber 21. As would be appreciated by those skilled in the art, when plunger 23 is longitudinally translated relative to barrel 18 as indicated by directional arrow A, pressure in internal chamber 21 increases and pharmaceutical 22 is dispensed from needle 16. While not previously indicated, it is contemplated that syringe 12 may include one or more features in addition to or in lieu of those described herein. Additionally, syringe 12 may be provided in alternative configurations, as would be appreciated by those skilled in the art.

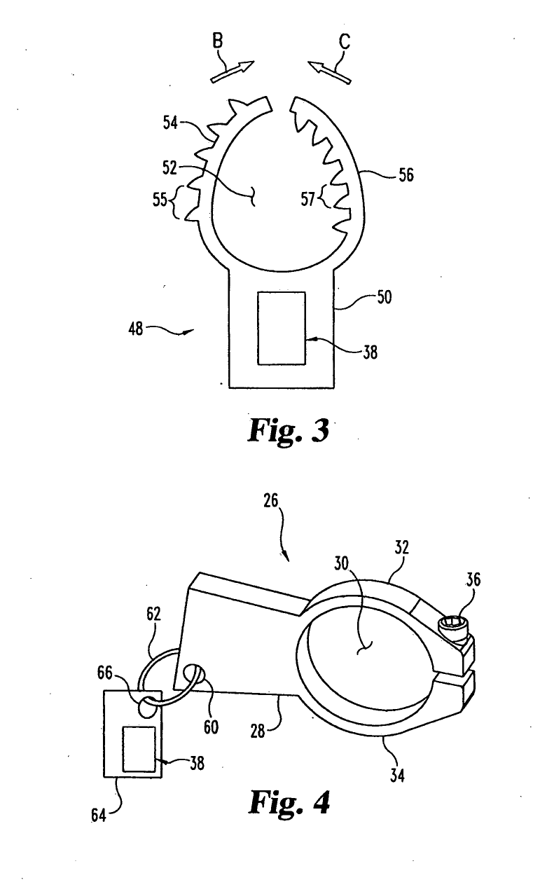

Syringe 12 also includes a flange 26 coupled with barrel 18 adjacent to second end 20, although alternative positioning of flange 26 is contemplated. As illustrated in FIG. 2, flange 26 includes a machine-readable and re-writable identifier 38 which stores information related to pharmaceutical 22 and, optionally, syringe 12. Further details of identifier 38 are provided below. While not illustrated, it is contemplated that flange 26 or another portion of syringe 12 may include information, such as a pharmaceutical label, concentration, or expiration date, stamped or marked on it. Flange 26 generally includes a body 28 from which a first arcuate engaging member 32 and a second arcuate engaging member 34 extend. Engaging members 32, 34 define a circular engaging portion 30 which substantially corresponds in size and shape to the exterior of barrel 18 of syringe 12. In embodiments not shown, engaging members 32, 34 and engaging portion 30 may be alternatively shaped and/or sized to accommodate syringe 12 or another type of delivery device 10 that has a different shape and/or size than syringe 12 illustrated in FIG. 1. Engaging members 32, 34 are, at least in part, flexibly positionable relative to one another to adjust the size of engaging portion 30 and accommodate a variety of syringes 12 falling within a certain size range. In order to ensure secure coupling of flange 26 to barrel 18, a set screw 36 extends through engaging member 32 and engages with a threaded aperture (not shown) in engaging member 34. As set screw 36 is rotatably engaged with the threaded aperture, engaging members 32, 34 are drawn together and engaging portion 30 is correspondingly closed to clamp flange 26 against barrel 18. Still, other arrangements for coupling engaging members 32 and 34 are contemplated.

Alternative arrangements for securing the coupling between flange 26 and barrel 18 are also possible. For example, in one form illustrated in FIG. 3, a flange 48 includes a body 50 from which a first engaging member 54 and a second engaging member 56 extend about an engaging portion 52. It should be appreciated that engaging member 54, 56 and engaging portion 52 may be sized and shaped in a configuration similar to engaging member 32, 34 and engaging portion 30 described above with respect to flange 26. Engaging members 54, 56 are flexibly positionable relative to one another and body 50 to adjust the size of engaging portion 52 to accommodate various sizes and shapes of syringe 12 or other types of delivery device 10. Once barrel 18 has been placed in engaging portion 52, engaging members 54 and 56 may be moved toward one another as indicated by directional arrows B and C, respectively. As engaging members 54, 56 are moved together, teeth 55, 57, which are positioned on surfaces of engaging members 54, 56 facing one another, begin to engage with each other in an interdigitating fashion. Teeth 55, 57 are angled relative to engaging members 54, 56, respectively, in a manner that prevents movement of engaging members 54, 56 in directions opposite of those indicated by directional arrows B and C, respectively, once teeth 55, 57 engage with each other. Engaging members 54, 56 may be continually moved toward one another, and teeth 55, 57 engaged with each other, until flange 48 is suitably coupled with syringe 12 or another type of delivery device 10.

In still another non-illustrated configuration, flange 26 is formed of a resilient, flexible material and engaging members 32, 34 are structured to deflect away from one another to facilitate a “snap-on” type of coupling with barrel 18. In other configurations, it is contemplated that flange 26 may coupled with barrel 18 by one or more adhesives, ties, cables, tethers, clamps, clasps, buckles, hooks or other types of fasteners and coupling arrangements, just to name a few possibilities. Additionally, flange 26 and the various configurations thereof may be removed from syringe 12 after pharmaceutical 22 has been discharged therefrom but before syringe 12 is discarded of otherwise disposed of. In this manner, flange 26 may be reused and coupled with another syringe 12, or other type of delivery device 10, which contains a new pharmaceutical or medical product. Similarly, identifier 38 can be rewritten to store information regarding the new pharmaceutical or medical product and, optionally, the new syringe 12 or the other type of delivery device 10. It should be appreciated that, during reuse of flange 26, the size adjustability of engaging portion 30 allows flange 26 to be coupled with a variety of alternatively configured syringes 12 or other types of delivery devices 10, including those sized and/or shaped differently from syringe 12 or another type of delivery device 10 to which flange 26 was previously coupled.

In the embodiments illustrated in FIGS. 2 and 3, identifier 38 may be attached to bodies 28, 50 of flanges 26, 48 in any suitable manner. A few non-limiting examples for attaching identifier 38 to flanges 26, 48 include one or more of pinning, tacking, gluing and adhering, just to name a few possibilities. Still, in another embodiment illustrated in FIG. 4, identifier 38 is attached to a tag 64 which is coupled to flange 26. More particularly, flange 26 has been modified to include an aperture 60 through which a coupling element 62 extends. Coupling element 62 also extends through an aperture 66 formed through tag 64 to couple tag 64 with flange 26. Coupling element 62 may be a ring, cable or wire including opposite ends which are releasably engageable with one another to couple tag 64 with flange 26. In this form, the ends of coupling element 62 can be disengaged to allow for removal of tag 64 from flange 26 once pharmaceutical 22 has been dispensed from syringe 12.

Alternatively, the opposite ends of coupling element 62 may be welded, fused, adhered or crimped to one another in a non-releasable manner to couple tag 64 and flange 26. In this form, the coupling element 62 can be cut or severed to allow for removal of tag 64 from flange 26. If tag 64 is removed from flange 26 it can be reused and coupled by a new coupling element 62 to another flange 26 which is coupled to a different syringe 12, or other type of delivery device 10, which contains a new pharmaceutical or medical product. Similarly, identifier 38 can be rewritten to store information regarding the new pharmaceutical or medical product and, optionally, syringe 12 or the other type of delivery device 10. Alternatively, in a non-illustrated embodiment, it is contemplated that syringe 12 or another type of delivery device 10 may include an aperture formed directly therein to which coupling element 62 may engage to couple tag 64 thereto, thereby eliminating the need to use flange 26. As an example of this embodiment, it is contemplated that syringe 12 or the other type of delivery device 10 may include an integrally formed flange similar to flange 26 to which tag 64 may be coupled.

Other variations with regard to the placement of identifier 38 relative to syringe 12 or other types of delivery device 10 are also contemplated. For example, in one or more forms where flange 26 and/or tag 64 are removed from syringe 12 and reused with a new syringe 12 or other type of delivery device 10, identifier 38 may be removed and replaced with a new identifier the same as or similar to identifier 38. In yet another form, it is contemplated that identifier 38 may be placed directly on syringe 12 or another type of delivery device 10, thereby eliminating the need for using flange 26, 48 or tag 64. In this form, it should be appreciated that each identifier 38 may be discarded with the used delivery device 10 and each new delivery device 10 may be provided with a new identifier 38. However, removal and reuse of identifier 38 are also contemplated.

As indicated above, identifier 38 is of a machine-readable and re-writable format operable to store information related to pharmaceutical 22 and, optionally, syringe 12. In one form, identifier 38 is a radio frequency identification (RFID) tag that includes an RF driver circuit and a coil antenna. The RF driver circuit generally includes a processor and memory and is operable to transmit and receive information to and from an RF reader/writer upon each interaction with the RF reader/writer. In this manner, data may be stored into and read from identifier 38 at different times and at different locations. In one form, the RF circuitry may be configured as a passive RF transponder that is energized by an external stimulation or excitation signal from an RF reader/writer that is received by the coil antenna. In response to being energized by a stimulation signal, the RF circuitry transmits and receives information to and from the RF reader with the coil antenna in a modulated RF format. In another form, the RF circuitry may be selectively or permanently active in nature, having its own internal power source. For such an alternative, power need not be derived from an external stimulus signal. Indeed, the RF circuitry could initiate communication instead. In yet another alternative form, the RF circuitry may include both active and passive circuits.

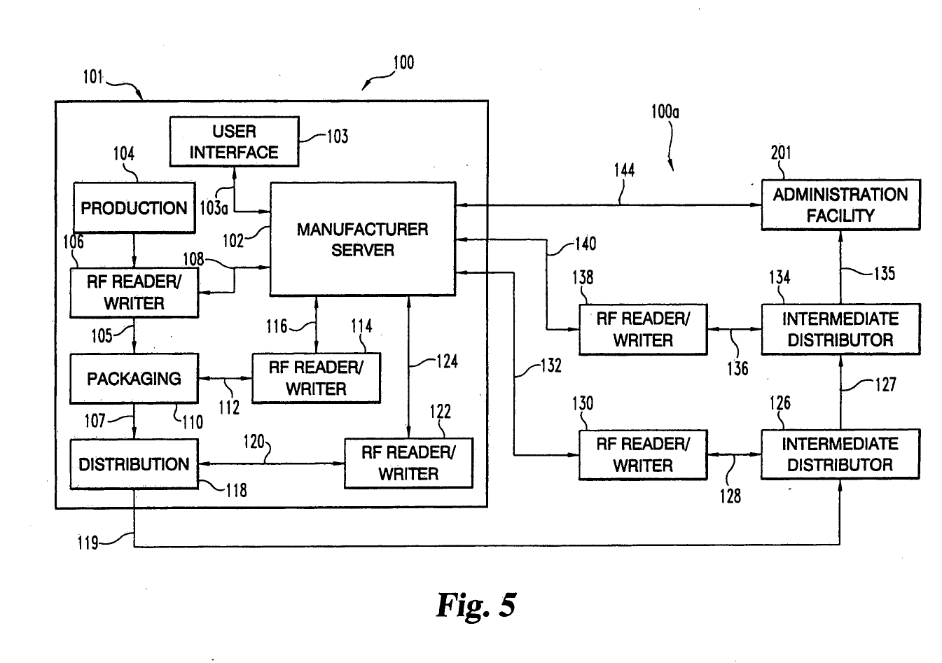

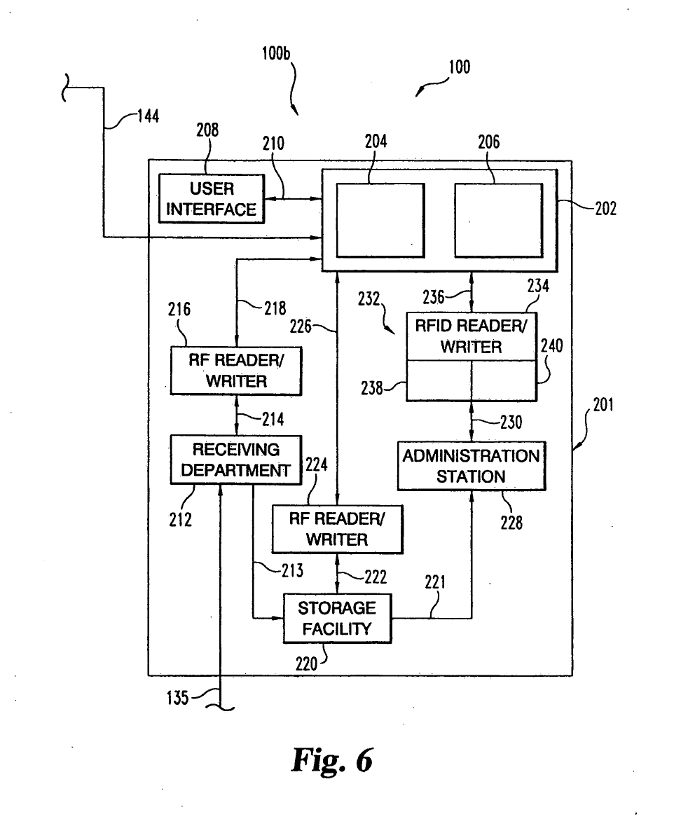

Referring now generally to FIGS. 5 and 6, there is schematically illustrated a system 100 for providing a pharmaceutical to a patient. For the sake of clarity, system 100 has been split into interconnected sections 100a and 100b in FIGS. 5 and 6, respectively. For the purposes of the instant description, it should be appreciated that section 100a generally illustrates the manufacture/production and distribution of the pharmaceutical to an administration facility 201, while section 100b generally illustrates the tracking and administering of the pharmaceutical to the patient within administration facility 201. However, it should be appreciated that system 100, as a whole, is responsible for performing each of these functions. Moreover, as will be explained further below, system 100 can be configured to allow a user to track and locate the pharmaceutical from the point of production to the point of administration and at each intermediate stage between production and administration to the patient. While system 100 is described herein with respect to a single pharmaceutical product, it should be appreciated that system 100 can be used for providing numerous pharmaceuticals to a variety of patients at a variety of administration facilities.

In FIG. 5, section 100a of system 100 illustrates a supply facility 101, such as a manufacturer, which includes a server 102, a production department 104, a packaging department 110, a distribution department 118 and RF readers/writers 106, 114, 122. It should be appreciated that supply facility 101 may include one or more elements in addition to or in lieu of those illustrated in FIG. 5. Moreover, it is contemplated that one or more of departments 104, 110, 118 may be provided outside supply facility 101 and/or may be excluded entirely from system 100. RF readers/writers 106, 114, 122 are coupled with server 102 through pathways 108, 116, 124, respectively, for bidirectional communication between each respective RF reader/writer 106, 114, 122 and server 102. It is contemplated that pathways 108, 116, 124 may represent one or more of a hard-wired or wireless connection between server 102 and each respective RF reader/writer 106, 114, 122 over a network such as a Local Area Network (LAN), Municipal Area Network (MAN), Wide Area Network (WAN), a combination of these, or such other network arrangement as would occur to those skilled in the art. In one form, the network is of a WAN type including the internet.

Server 102 is generally operable to store information regarding the manufacture, distribution and administration of a pharmaceutical product, provide such information to a user, and control one or more operating parameters of system 100. However, it should be appreciated that other operating functions of server 102 are contemplated by the present application. In one form, server 102 is a computer that includes one or more processors or CPUs and one or more types of memory. Each processor may be comprised of one or more components configured as a single unit. When of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement.

Each memory is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

A user interface 103 is coupled to server 102 via pathway 103a includes an output providing information from server 102 to a user and one or more user input devices for entering information into server 102 or changing one or more operating parameters of system 100. When included, the output can be a display of a Cathode Ray Tube (CRT) type, Liquid Crystal Display (LCD) type, plasma type, Organic Light Emitting Diode (OLED) type, a printer, or other types as would occur to those skilled in the art. Moreover, the user input devices may include one or more of a keyboard, mouse, track ball, light pen, and/or microtelecommunicator, to name just a few representative examples.

Production department 104 is generally operable to produce and provide a pharmaceutical in a delivery device. In one particular example which will be described with respect to system 100, production department 104 fills and provides syringe 12 with pharmaceutical 22 as illustrated in FIG. 1 and described above. However, it should be appreciated that production department 104 may provide delivery devices other than syringe 12. With further regard to the instant example, supply facility 101 manufactures both syringe 12 and pharmaceutical 22 and fills syringe 12 with pharmaceutical product 22 at production department 104. Alternatively, supply facility 101 only manufactures one of syringe 12 and pharmaceutical 22 or may not manufacture either of syringe 12 and pharmaceutical 22. Instead, supply facility has one or both of pharmaceutical 22 and syringe 12 supplied to it and then fills syringe 12 with pharmaceutical 22 at production department 104. Pharmaceutical 22 may be any one of a variety of liquid drug products administered to a patient. When provided in syringe 12, pharmaceutical 22 is of the type which is injected intramuscularly, intravenously or otherwise into the patient. In one form, it is contemplated that pharmaceutical 22 may be provided in syringe 12 in an amount that is typical for a single dosage to a certain type of patient. More particularly, the appropriate relationship between volume and concentration of pharmaceutical 22 which is necessary for a single dosage to a patient of a certain class of patients may be determined and dispensed into syringe 12. For example, in one form it is contemplated that syringe 12 may be loaded with pharmaceutical 22 in a form suitable for single dosage injection to adults instead of children, although other variations and identifications of classes are contemplated. Thus, in one form syringe 12 is configured for simple administration of pharmaceutical 22 to a patient which eliminates the need for a healthcare worker to measure, mix, formulate or otherwise prepare pharmaceutical 22.

Each syringe 12 provided by production department 104 includes an identifier 38 onto which information related to pharmaceutical 22 and, optionally, syringe 12, can be written. As the information is written onto each identifier 38, a unique code is assigned to each and a file based on each unique code is created on server 102 to store information regarding each syringe 12. In one form, it is contemplated that the information stored in each identifier 38 is also stored in the corresponding file on server 102 and vice versa. In this configuration, each time identifier 38 interacts with an RF reader in bidirectional communication with server 102, identifier 38 and its respective file on server 102 are reconciled so that each includes the same information. However, it should be appreciated that identifier 38 or its respective file on server 102 may include information that is unique to it; i.e., such information is not stored on the other of identifier 38 and server 102.

As syringe 12 leaves production department 104, RF reader/writer 106 writes information onto identifier 38. The information written by RF reader/writer 106 and stored on identifier 38 may identify specifications and/or characteristics of pharmaceutical 22, including without limitation, any one or more of its name, class, type, concentration, volume, manufacturing date, expiration date, lot number, chemical formula, active ingredient, pharmacology, mechanism of action, targeted disease states/conditions and manufacturer. This information may also identify known adverse drug/drug interactions and contraindications of pharmaceutical 22. Where pharmaceutical 22 is provided in a dosage intended to be administered to a patient falling within a specific class or classes of patients, the information on identifier 38 may also identify the members of the class or classes. For example, it might identify that pharmaceutical 22 in syringe 12 should be administered to patients falling within one or more of a certain age, weight, sex or disease state class, just to name a few possibilities. While not previously discussed, it should be appreciated that the information stored onto identifier 38 upon interaction with RF reader/writer 106 may be first added onto server 102 by a user at interface 103 or, alternatively, it is contemplated that one or both of server 102 and RF reader/writer 106 may be automatically updated with information from production department 104 as it provides syringes 12. It should be appreciated that a user may utilize interface 103 to continually update the information stored in the file on server 102 associated with identifier 38 such that the information on identifier 38 can be correspondingly updated each time it interacts with an RF reader/writer in communication with server 102. Additionally, it is contemplated that RF reader/writer 106 may be operable to provide identifier 38 with the date and/or time it interacts with RF reader/writer 106.

After identifier 38 has been loaded with the above-described information, syringe 12 is moved to packaging department 110, as indicated by arrow 105. At packaging department 110, syringe 12 may be individually packaged for distribution beyond supply facility 101. Alternatively, a plurality of syringes 12 could be grouped together and placed in shared packaging. RF reader/writer 114 interacts with identifier 38 of syringe 12 as indicated by communication pathway 112 to provide identifier 38 with the time and/or date at which syringe 12 is received into and leaves from packaging department 110. RF reader/writer 114 is also operable to update any information previously stored on identifier 38 and may write other information, such as a product recall, onto identifier 38. Once properly packaged, syringe 12 is passed along to distribution department 118 as indicated by arrow 107. RF reader/writer 122 associated with distribution department 118 interacts with identifier 38 of syringe 12 as indicated by communication pathway 120 to provide the time and/or date at which syringe 12 is received into and leaves from distribution department 118. RF reader/writer 122 is also operable to update any information previously stored on identifier 38 and may write other information, such as a targeted destination for syringe 12, onto identifier 38. Moreover, in one form, when syringe 12 leaves supply facility 101 server 102 is operable to send a report, such as an email, to the party that ordered syringe 12 and/or to any party or parties that will be involved in the distribution of syringe 12.

It is contemplated that syringe 12 may pass through one or more intermediate distributors, such as warehouses for example, between supply facility 101 and administration facility 201. For example, as illustrated in FIG. 5, syringe 12 passes from supply facility 101 to intermediate distributor 126, as indicated by arrow 119, and from intermediate distributor 126 to intermediate distributor 134, as indicated by arrow 127, before it reaches administration facility 201. Intermediate distributor 126 includes an RF reader/writer 130 which is connected with server 102 via pathway 132 to bidirectionally communicate therewith. RF reader/writer 130 interacts with identifier 38 of syringe 12 as indicated by communication pathway 128 to provide the time and/or date at which syringe 12 is received into and leaves from intermediate distributor 126. RF reader/writer 130 is also operable to update any information previously stored on identifier 38 and may write other information, such as the location of intermediate distributor 126 or the conditions in which syringe 12 is being stored, onto identifier 38. Similar to intermediate distributor 126, intermediate distributor 134 includes an RF reader/writer 138 which is coupled with server 102 via pathway 140 to bidirectionally communicate therewith. RF reader/writer 138 interacts with identifier 38 of syringe 12 as indicated by communication pathway 136 to provide the time and/or date at which syringe 12 is received into and leaves from intermediate distributor 134. RF reader/writer 138 is also operable to update any information previously stored on identifier 38 and may write other information, such as the location of intermediate distributor 134 or the conditions in which syringe 12 is being stored, onto identifier 38. It is contemplated that pathways 132, 140 may represent one or more of a hard-wired or wireless connection between server 102 and RF readers/writers 130, 138 over a network such a Local Area Network (LAN), Municipal Area Network (MAN), Wide Area Network (WAN), a combination of these, or such other network arrangement as would occur to those skilled in the art. In one form, the network is of a WAN type including the internet.

Syringe 12 is delivered to administration facility 201 from intermediate distributor 134 as indicated by arrow 135. Administration facility 201 may be a hospital, pharmacy, nursing home, clinic or physician's office, just to name a few possibilities. In the embodiment illustrated in FIG. 6, administration facility 201 generally includes a management computer 202, a receiving department 212, a storage facility 220, an administration station 228, an administration terminal 232 which includes RF reader/writer 234, and RF readers/writers 216 and 224. However, it should be appreciated that administration facility 201 may include one or more elements in addition to or in lieu of those illustrated and described herein. Administration terminal 232 and RF readers/writers 216, 224 are coupled with management computer 202 through pathways 236, 218 and 226, respectively, for bidirectional communication between management computer 202 and each of respective administration terminal 232 and RF readers/writers 216, 224. Additionally, management computer 202 is coupled with server 102 at supply facility 101 through pathway 144 for bidirectional communication between management computer 202 and server 102. It should be appreciated that management computer 202 can be programmed to only share certain information with server 102. For example, management computer 202 may be configured to prohibit any confidential patient information from being transmitted to server 102 in order to comply with various local, state and federal regulations. Pathways 144, 218, 226, 236 may represent one or more of a hard-wired or wireless connection over a network such a Local Area Network (LAN), Municipal Area Network (MAN), Wide Area Network (WAN), a combination of these, or such other network arrangement as would occur to those skilled in the art. In one form, the network is of a WAN type including the internet.

Management computer 202 includes one or more processors or CPUs and one or more types of memory. Each processor may be comprised of one or more components configured as a single unit. When of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement.

Each memory is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties. As illustrated in FIG. 6, at least a portion of the memory is used for storing patient information in a patient file 204 uniquely associated with a patient of administration facility 201 while another portion of the memory is used for providing a virtual inventory 206 of the pharmaceutical products at administration facility 201. While only one patient file 204 has been illustrated on management computer 202 in FIG. 6, it should be appreciated that management computer 202 is generally operable to create and store a similar file for each patient of facility 201.

A user interface 208 is coupled to management computer 202 via pathway 210 and may include an output providing information from management computer 202 to a user and one or more user input devices for entering information into management computer 202. When included, the output can be a display of a Cathode Ray Tube (CRT) type, Liquid Crystal Display (LCD) type, plasma type, Organic Light Emitting Diode (OLED) type, a printer, or other types as would occur to those skilled in the art. Moreover, the user input devices may include one or more of a keyboard, mouse, track ball, light pen, and/or microtelecommunicator, to name just a few representative examples.

In one form, a user may utilize user interface 208 for entering patient information into patient file 204 saved on management computer 202. More particularly, in one exemplary form, a user may take information related to the patient's medical history from the patient upon the patient's initial visit or admittance to administration facility 201 and enter it at user interface 208 to create patient file 204. The information in patient file 204 may identify one or more of the name, age, sex, height, weight, physician, known allergies, diet restrictions, weight restrictions, emergency contacts, family members, place of employment, insurance company, previous pharmaceutical use, previous illnesses/diseases, previous surgeries, existing pharmaceutical use, existing medical conditions, existing treatment plans and medical condition giving rise to the current treatment of the patient. Additionally, user interface 208 may be used by one or more healthcare workers to enter information into patient file 204 regarding the current treatment of the patient. For example, such information may identify a physician order, such as a prescription, indicating the type and amount of a pharmaceutical which should be administered to the patient along with details identifying the date and/or time when the pharmaceutical should be administered to the patient. It should be appreciated that patient file 204 may be updated to reflect changes regarding the patient's medical history or treatment that may occur during the patient's visit or admittance to administration facility 201 or that might have occurred since the patient's initial visit or admittance to administration facility 201. Thus, patient file 204 has the potential to become an ongoing comprehensive medical file of the patient which includes not only information related to the patient's association with administration facility 201, but also provides an overall detailed medical history for the patient.

When syringe 12 is received in receiving department 212, RF reader/writer 216 interacts with identifier 38 as indicated by communication pathway 214 and the virtual inventory 206 is updated to indicate receipt of syringe 12. In one form, virtual inventory 206 creates a file for syringe 12 based on the unique code assigned to identifier 38 at supply facility 101. The file created on virtual inventory 206 for syringe 12 may store all or part of the information that has been previously written on identifier 38 before syringe 12 is received by administration facility 201. This file may also include an indication as to the current location of syringe 12 within administration facility 201 as well as the time and date when syringe 12 was received by, and is subsequently moved around, administration facility 201. As indicated above, server 102 and management computer 202 bidirectionally communicate with each other through pathway 144. In one configuration, the information on virtual inventory 206 is shared with server 102 and server 102, which identifies the unique code assigned to identifier 38, is updated to reflect receipt of syringe 12 by administration facility 201. More particularly, server 102 may be updated to include the time and/or date when syringe 12 was received by administration facility 201 or is subsequently moved within administration facility 201. In this configuration, server 102 can also provide virtual inventory 206 with updates, such as recall or expiration information for example, that should be written onto identifier 38. Virtual inventory 206 correspondingly provides these updates to RF reader/writer 216 where they are written onto identifier 38. It should be appreciated that virtual inventory 206 can be continually updated each time identifier 38 interacts with an RF reader/writer in administration facility 201 until pharmaceutical 22 is administered to the patient. Likewise, server 102 may also be correspondingly updated to reflect the location/status of syringe 12. Additionally, server 102 can periodically provide updates regarding pharmaceutical 22 to virtual inventory 206 which in turn updates identifier 38 each time it interacts with an RF reader/writer at administration facility 201.

In an alternative configuration, management computer 202 may be configured to allow server 102 to directly communicate with administration terminal 232 and RF readers/writers 216, 224 to determine the status/location of syringe 12 and/or provide updates to be stored on identifier 38. Thus, the need for intermediate communication between server 102 and virtual inventory 206 is eliminated. However, server 102 may still communicate with virtual inventory 206 to receive orders for additional pharmaceutical products or the like. In this configuration, it should be appreciated that management computer 202 is still generally operable to filter any confidential information from being passed to server 102.

It is contemplated that syringe 12 may pass through one or more storage facilities within administration facility 201 between receiving department 212 and administration station 228. For example, as illustrated in FIG. 6, syringe 12 passes from receiving department 212 to storage facility 220, as indicated by arrow 213. Storage facility 220 may be, for example, a pharmacy, medication dispensing unit, cart, chest or room, just to name a few possibilities. Storage facility 220 includes an RF reader/writer 224 which interacts with identifier 38 of syringe 12 as indicated by communication pathway 222 to provide the time and/or date at which syringe 12 is received into and leaves from storage facility 220. RF reader/writer 224 is also operable to update any information previously stored on identifier 38 and may write other information, such as the location of storage facility 220 within administration facility 201, onto identifier 38.

Syringe 12 is delivered to administration station 228 from storage facility 220 as indicated by arrow 221. Administration station 228 may be, for example, a pharmacy counter or a patient's bedside or chairside, just to name a few representative possibilities. In the embodiment illustrated in FIG. 6, administration terminal 232 is positioned adjacent to administration station 228. Administration terminal 232 includes RF reader/writer 234 and a user input 238 and an output 240. Output 240 can be a display of a Cathode Ray Tube (CRT) type, Liquid Crystal Display (LCD) type, plasma type, Organic Light Emitting Diode (OLED) type, a printer, or other types as would occur to those skilled in the art. Moreover, user input 238 may include one or more of a keyboard, mouse, track ball, light pen, and/or microtelecommunicator, to name just a few representative examples.

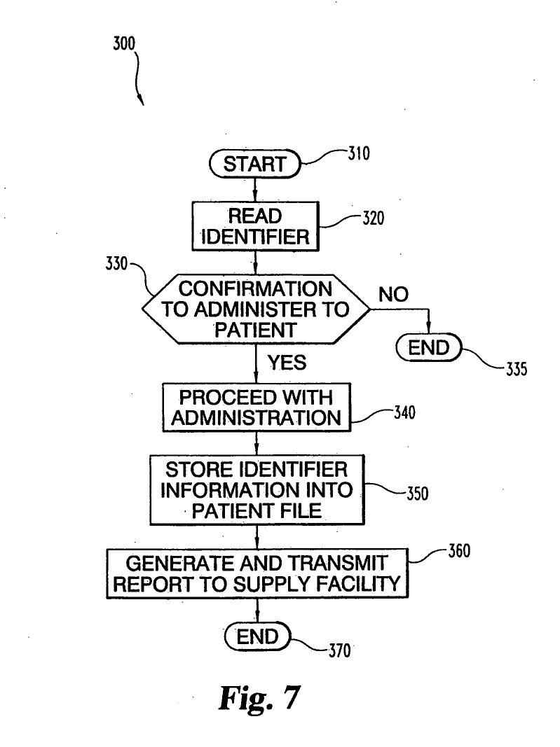

When a healthcare worker is ready to administer pharmaceutical 22 to a patient at administration station 228, one procedure 300 for doing such is set forth in FIG. 7. For example, at step 310 the healthcare worker can start procedure 300 followed by reading identifier 38 with RF reader/writer 234 at step 320. At step 330, the healthcare worker must determine if there is a confirmation for administering the pharmaceutical to the patient. More particularly, the information stored on identifier 38 is compared with the patient's medical history and other information stored in patient file 204 by management computer 202 to determine if pharmaceutical 22 should be administered to the patient. For example, management computer 202 is configured to detect conflicts between pharmaceutical 22 and an allergy of the patient or a pharmaceutical currently used by the patient. As another example, management computer 202 is configured to detect a conflict between pharmaceutical 22 and the patient's treatment plan or the prescription(s) entered into patient file 204 by a physician or other healthcare worker. As yet another example, management computer 202 is operable to determine if the time/date when identifier 38 is read by RF reader/writer 138 corresponds with the time/date identified in patient file 204 for administering pharmaceutical 22. In still another example, when identifier 38 identifies a targeted class of recipients for pharmaceutical 22, management computer 202 may be operable to determine if the patient is a member of the class. As yet another example, management computer 202 is operable to determine if a conflict exists between the dosing information provided on identifier 38 and the physician's order prescribing administration of pharmaceutical 22 to the patient. Still, it is contemplated that management computer 202 is operable to detect and consider other aspects of the information stored on identifier and the information stored in patient file 203 which could have a bearing on administration of pharmaceutical 22 to the patient.

In response to comparing the information stored on identifier 38 and the patient's medical history and other information stored in patient file 204, management computer 202 provides a signal to output 240 which generates an indication to the healthcare worker whether administration of pharmaceutical 22 to the patient is proper. If administration is proper, output 240 will provide confirmation of same to the healthcare worker and the healthcare worker may continue with administration of pharmaceutical 22 to the patient, as indicated at step 340 of procedure 300. However, if output 240 does not provide a confirmation to administer pharmaceutical 22 to the patient, procedure 300 should be ended as indicated at step 335. In addition to the foregoing, output 240 may be responsive to a signal from management computer 202 or information stored on identifier 38 to indicate that pharmaceutical 22 should not be administered to the patient because it has expired or been recalled. Moreover, when pharmaceutical 22 is provided in a dosage intended to be administered to a patient belonging to a specific class or classes of patients and identifier 38 identifies the members of the class or classes, it is contemplated that such information may also be used by the healthcare worker to at least preliminarily determine if pharmaceutical 22 should be administered to the patient in addition to reliance on the indication provided by output 240. For example, this information from identifier 38 can be displayed on output 240 for inspection by the healthcare worker so the healthcare worker can determine if the patient is one of the identified members of the class or classes. For example, where the identified members are males, the healthcare worker will be able to readily ascertain whether the patient is a male or female. If the patient is a member of the class, then the healthcare worker should continue with the indication provided by output 240. However, if the patient is not a member of the class, then the healthcare worker should not administer pharmaceutical 22 to the patient. This type of secondary consideration based on the information of identifier 38 at least partially safeguards against the situation where the physician's order prescribing administration of pharmaceutical 22 stored in patient file 204 is incorrect.

Upon administration of pharmaceutical 22 to the patient, the healthcare worker can enter details of same at user input 238. Alternatively, identifier 38 can automatically provide an indication to RF reader/writer 234 that pharmaceutical 22 has been administered. It should be appreciated that these details can indicate the time, date, dosage and/or location in administration facility 201 of administration of pharmaceutical 22 to the patient, just to name a few possibilities. The information regarding administration of pharmaceutical 22 to the patient is used to update virtual inventory 206 so that additional shipments of pharmaceutical 22 from supply facility 101 can be requested. In one form, management computer 202 automatically generates and sends an order to supply facility 101 or another distributor or supplier each time pharmaceutical 22 is administered to the patient. Alternatively, management computer 202 may wait until a threshold number of administrations of pharmaceutical 22 have occurred and then send a more cumulative order to supply facility 101 or other distributor or supplier.

The information regarding administration of pharmaceutical 22 to the patient is also stored in patient file 204 to create a history of administration of pharmaceutical 22 to the patient and indicate that the physician's order corresponding to administration of pharmaceutical 22 to the patient was followed. The healthcare worker may also utilize user input 238 to enter details into patient file 204 regarding the physical condition of the patient at the time of administration and/or at other times during the patient's visit or admittance to administration facility 201. Examples of details regarding the physical condition of the patient may include the patient's blood pressure, heart rate, temperature, hydration level and/or physical appearance, just to name a few possibilities. As another possibility, the healthcare worker could utilize user input 238 to enter an order prescribing pharmaceutical treatment of the patient into patient file 204. Still, information indicating any side effects of pharmaceutical 22 experienced by the patient may also be entered into patient file 204 from input 238.

As indicated at step 350 of procedure 300, the information stored in identifier 38 is also stored in patient file 204 in response to administration of pharmaceutical 22 to the patient. Thus, patient file 204 includes a comprehensive record of the patient's medical history along with the information from identifier 38 providing details of pharmaceutical 22. It should be appreciated that patient file 204 may be updated to include the above described information each time a pharmaceutical is administered to the patient by administration facility 201. As indicated by step 360 of procedure 300, a report is generated and transmitted to supply facility 101 regarding the administration of pharmaceutical 22 to the patient. In one form, management computer 202 automatically generates and sends the report to supply facility 101 each time pharmaceutical 22 is administered to the patient. Alternatively, management computer 202 may wait until a threshold number of reports have been generated before it sends them to supply facility 101. Indeed, in one form, management computer 202 may be operable to create a comprehensive report of all the pharmaceutical products administered in administration facility 201 and supplied by supply facility 101.

Generally, the report includes non-confidential information stored in patient file 204, all or part of the information stored on identifier 38 and/or the details associated with administration of pharmaceutical 22 to the patient. It is also contemplated that the report can identify the geographic location and type of administration facility 201. Supply facility 101 may then use the information from the report to determine various aspects of the distribution and administration of pharmaceutical 22. For example, supply facility 101 could determine the market penetration of pharmaceutical 22, the time between production and administration of pharmaceutical 22, the prescribed uses of pharmaceutical 22 and/or the success of pharmaceutical 22 in treating certain medical conditions.

When pharmaceutical 22 has been administered from syringe 12, administration facility 201 may remove flange 26 with identifier 38, return it to supply facility 101, and dispose of syringe 12 in accordance with accepted protocol. Supply facility 101 may then erase or delete the information from identifier 38 and reuse flange 26 with another product. Alternatively, syringe 12, including flange 26 and identifier 38, may be properly disposed of without returning any components to supply facility 101.

As indicated above, system 100 allows supply facility 101 to determine the location/status of syringe 12 at every stage between production and administration of pharmaceutical 22 to the patient at administration facility 201. Additionally, system 100 allows the information on identifier 38 to be updated or supplemented upon interaction with an RF reader/writer up until administration of pharmaceutical 22 to the patient. For example, identifier 38 could be updated to include recall information, new dosing guidelines and/or newly discovered contraindications or adverse drug/drug interactions, just to name a few possibilities. While not previously described, it is contemplated that each of RF readers/writers 106, 114, 122, 130, 138, 216, 224 of system 100 can include a user input and an output similar to user input 238 and output 240 described above in connection with administration terminal 232. In this form, the output could provide an indication to a party at each respective RF reader/writer 106, 114, 122, 130, 138, 216, 224 to take a particular action with respect to syringe 12. For example, if pharmaceutical 22 has expired or been recalled, the indication might instruct the party to remove syringe 12 from distribution and return it to supply facility 101. As a corollary, syringe 12 could be removed from distribution and disposed of or returned to supply facility 101 before it ever reaches administration facility 201. Likewise, the risk of administering a recalled or expired product to the patient is greatly reduced. In addition, the ability to locate and track syringe 12 at every stage of distribution and administration allows supply facility 101 to contact the party in possession of syringe 12 to notify it that syringe 12 has been recalled. As a corollary, the need for the party in possession of syringe 12 to specifically review its inventory to determine if it has products subject to the recall is eliminated.

In one embodiment, the present application provides a system which facilitates an extensive interaction between a patient's comprehensive medical record stored in an electronic patient file and information related to a pharmaceutical product stored in an RFID tag attached to a delivery device storing the pharmaceutical product. The system is operable to detect conflicts between the patient's medical history and the pharmaceutical product to determine if administration of the pharmaceutical product to the patient is appropriate. Furthermore, the system interacts with a physician's order stored in the electronic patient file and prescribing administration of the pharmaceutical to the patient to detect for conflicts between the order and the pharmaceutical product. If administration of the pharmaceutical product to the patient is appropriate, an indication is provided to a healthcare professional to proceed with same. In response to administering the pharmaceutical product to the patient, the information from the RFID tag is stored in the electronic patient file and a report is generated and transmitted to the manufacturer providing details of the administration of the pharmaceutical product. In one form, the report includes at least some of the non-confidential information stored in the electronic patient file along with all or part of the information stored in the RFID tag.

Another embodiment of the application is directed to a method for tracking a pharmaceutical product from its time of production until the time it is administered to a patient. More particularly, a machine-readable and re-writable identifier attached to a delivery device containing the pharmaceutical product interacts with a reader/writer each time it changes possession between parties and provides tracking information to the manufacturer. In one form of this embodiment, each reader/writer is operable to update information stored on the identifier. In one example, the information on the identifier provides details regarding the pharmaceutical product contained in the delivery device. The method also includes providing an indication to a party that instructs the party to take some action regarding the pharmaceutical product. The action may be, for example, removing the pharmaceutical product from distribution and returning it to the manufacturer, although other actions are contemplated.

In yet another embodiment, a method includes attaching a machine-readable and re-writable identifier to a plurality of delivery devices pre-filled with a pharmaceutical product. The identifier includes information providing details regarding the pharmaceutical product. The method also includes distributing the delivery devices to an administration facility; administering the pharmaceutical products to patients at the administration facility; and, in response to administering, generating and transmitting a report to a third party outside the administration facility. The report generally provides non-confidential information of the patients to whom the pharmaceutical product was administered, along with at least part of the information stored on the identifier, although additional information can be included. In one form, the method further includes receiving the report and, in response to receiving the report, creating a database archiving various aspects of the distribution and administration of the pharmaceutical product. The database may include, for example, the market penetration of the pharmaceutical products; the length of time involved between the production and administration of the pharmaceutical products; the medical conditions treated by the pharmaceutical products; the type or types of patients to which the pharmaceutical products are typically administered; the effects the administration of the pharmaceutical products has on the treatment of patients; and/or the typical side effects, if any, experienced by patients to which the pharmaceutical products are administered.

In still another embodiment, a method includes creating an electronic patient file at an administration facility. More particularly, the method includes gathering details of a patient's comprehensive medical history and entering same into the electronic file. The details of the patient's medical history can identify, without limitation, one or more of the name, age, sex, height, weight, physician, known allergies, diet restrictions, weight restrictions, emergency contacts, family members, place of employment, insurance company, previous pharmaceutical use, previous illnesses/diseases, previous surgeries, existing pharmaceutical use, existing medical conditions, existing treatment plans, medical condition(s) giving rise to current treatment and current treatment plan(s) of the patient. The current treatment plan(s) can include, for example, a physician's order prescribing administration of a pharmaceutical product to the patient. The method also includes administering the pharmaceutical product to the patient and, in response to administering the pharmaceutical product, updating the electronic patient file to include manufacturer information related to the pharmaceutical product. In one form, the manufacturer information is stored in a machine-readable and re-writable identifier attached to a delivery device containing the pharmaceutical product. In this form, updating the electronic patient file includes reading the manufacturer information with a machine reader while simultaneously administering the pharmaceutical product.

Yet a further embodiment of the present application is directed to a method which includes providing a pharmaceutical including a machine-readable and re-writable identifier, the identifier storing manufacturer information unique to the pharmaceutical; administering the pharmaceutical to a patient while simultaneously reading the identifier and storing the manufacturer information in an electronic file of the patient; and in response to storing the information, generating and transmitting a report to a supplier of the pharmaceutical, the report including the manufacturer information and at least a portion of the electronic file.

In still another alternative embodiment, a method for providing a pharmaceutical to a patient includes filling at least one delivery device with the pharmaceutical. The at least one delivery device includes a machine-readable and re-writable identifier including pharmaceutical information identifying characteristics of the pharmaceutical. The method also includes supplying the at least one delivery device to an administration facility; reading the identifier at the administration facility and comparing the pharmaceutical information with a file uniquely associated with the patient to detect a confirmation for administering the pharmaceutical to the patient; and in response to the confirmation, administering the pharmaceutical to the patient and storing the pharmaceutical information in said file.

In an even further embodiment, the present application provides a system for providing a pharmaceutical to a patient. The system generally includes at least one delivery device containing the pharmaceutical and including an RFID identifier. The identifier stores specifications of the pharmaceutical. At least one reader operable to read the specifications from the identifier and a computer coupled with the at least one reader are also included in the system. The computer is operable to download the specifications into a file uniquely associated with the patient and to generate and transmit a report to a supplier of the pharmaceutical upon administration of the pharmaceutical to the patient. The report includes the specifications and at least a portion of the file.

Any theory, mechanism of operation, proof, or finding stated herein is meant to further enhance understanding of the present application and is not intended to make the present application in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the application, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the application has been illustrated and described in detail in the drawings and foregoing description, the same is to be considered as illustrative and not restrictive in character, it being understood that only the selected embodiments have been shown and described and that all changes, modifications and equivalents that come within the spirit of the application as defined herein or by any of the following claims are desired to be protected.

What is claimed is:

1. A method, comprising:
providing a pharmaceutical including a machine-readable and re-writable identifier, said identifier storing information unique to said pharmaceutical;
administering said pharmaceutical to a patient while simultaneously reading said identifier and storing said information unique to said pharmaceutical in an electronic file of the patient; and
in response to storing said information, generating and transmitting a report to a supplier of the pharmaceutical, said report including said information unique to said pharmaceutical and at least a portion of said electronic file.

2. The method of claim 1, wherein said identifier is an RFID device.

3. The method of claim 1, wherein said information unique to said pharmaceutical identifies a name of said pharmaceutical and at least one of a class, concentration, volume, expiration date, lot number and manufacturer of the pharmaceutical.

4. The method of claim 1, wherein said electronic file includes a physician order to administer said pharmaceutical to the patient and information identifying at least one of a sex, age, weight, current diagnosis, status of a current disease state, allergy, existing medical condition, existing medical therapy and existing pharmaceutical use, of the patient.

5. The method of claim 1, which includes entering and storing details associated with administering the pharmaceutical to the patient in said electronic file.

6. The method of claim 5, wherein said details identify at least one of a geographic location, time, date and dosage amount of administration of said pharmaceutical.

7. The method of claim 1, wherein said supplier is a manufacturer of the pharmaceutical.

8. The method of claim 1, which includes updating an electronic inventory in response to administering the pharmaceutical.

9. A method for providing a pharmaceutical to a patient, comprising:
filling at least one delivery device with the pharmaceutical, said at least one delivery device including a machine-readable and re-writable identifier including pharmaceutical information identifying characteristics of the pharmaceutical;
supplying said at least one delivery device to an administration facility;
reading said identifier at said administration facility and comparing said pharmaceutical information with a file uniquely associated with the patient to detect a confirmation for administering the pharmaceutical to the patient; and
in response to the confirmation, administering the pharmaceutical to the patient and storing said pharmaceutical information in said file.

10. The method of claim 9, wherein said characteristics include manufacturing details which identify a name of the pharmaceutical and at least one of a class, concentration, volume, expiration date, lot number and manufacturer of the pharmaceutical.

11. The method of claim 10, wherein said file is provided in an electronic format and includes patient information representative of a medical record of the patient.

12. The method of claim 11, wherein said medical record includes a physician order to administer said pharmaceutical to the patient and information identifying at least one of a sex, age, weight, current diagnosis, status of a current disease state, allergy, existing medical condition, existing medical therapy and existing pharmaceutical use, of the patient.

13. The method of claim 9, wherein said identifier further includes an indication of a targeted class of recipients of the pharmaceutical, said indication based on one or more of said characteristics of the pharmaceutical.

14. The method of claim 9, wherein said identifier is attached to a flange removably coupled with said at least one delivery device.

15. The method of claim 14, wherein said flange includes a pair of engaging members defining an engaging portion, said engaging members being selectively positionable relative to one another to adjust a size of the engaging portion.

16. The method of claim 15, wherein each of said pair of engaging members includes a plurality of teeth positionable in an interdigitating arrangement with the plurality of teeth of the other engaging member.

17. The method of claim 9, which includes generating and transmitting a report to a supplier of the pharmaceutical in response to storing said pharmaceutical information in said file, said report including said pharmaceutical information and at least a portion of said file.

18. The method of claim 9, wherein said administration facility is selected from the group consisting of a nursing home, hospital, physician's office, clinic and pharmacy.

19. The method of claim 9, which includes transferring possession of said at least one delivery device on one or more occasions between said filling and said supplying, said transferring including reading said identifier and identifying a location of said at least one delivery device on each of said one or more occasions.

20. A system for providing a pharmaceutical to a patient, comprising:
at least one delivery device containing the pharmaceutical and including an RFID identifier, said identifier storing specifications of the pharmaceutical;
at least one reader operable to read the specifications from said identifier; and
a computer coupled with said at least one reader, said computer being operable to download said specifications into a file uniquely associated with the patient and to generate and transmit a report to a supplier of the pharmaceutical upon administration of the pharmaceutical to the patient, said report including said specifications and at least a portion of said file.

21. The system of claim 20, wherein said computer is operable to compare said specifications with said file to provide a confirmation to a user to administer the pharmaceutical to the patient.

22. The system of claim 21, wherein said specifications include means for identifying a name of the pharmaceutical and at least one of a class, concentration, volume, expiration date, lot number and manufacturer of the pharmaceutical.

23. The system of claim 21, further comprising a user input device coupled with said computer, said user input device including means for entering details associated with administration of the pharmaceutical to the patient in said file.

24. The system of claim 21, wherein said computer is coupled with an electronic inventory of a healthcare facility and is operable to update said inventory upon administration of the pharmaceutical to the patient.

25. The system of claim 20, wherein said at least one delivery device includes a flange removably coupled thereto, said flange including said RFID identifier.
